(19) United States
(12) Patent Application Publication
(10) Pub. No.: US 2021/0345565 A1
(43) Pub. Date: Nov. 11, 2021

(54) Container Garden Irrigation Assembly

(71) Applicant: Rodney Farringer, Canton, OH (US)

(72) Inventor: Rodney Farringer, Canton, OH (US)

(21) Appl. No.: 16/869,766

(22) Filed: May 8, 2020

(51) Int. Cl. A01G 25/16; A01G 25/02

(52) U.S. Cl. CPC A01G 25/165; A01G 25/02

(57) ABSTRACT

A container garden irrigation assembly includes a reservoir for containing a fluid. A pump is positioned inside the reservoir thereby facilitating the pump to be submerged in the fluid. A control unit provided that is in electrical communication with the pump. The control unit turns the pump on and off at predetermined times of day. A pair of irrigation units is each in fluid communication with the pump to receive the fluid from the pump. Each of the irrigation units has a plurality of irrigation ports therein and each of the irrigation units is positioned over a container garden. Moreover, each of the irrigation ports is aligned with a respective one of a plurality of containers in the container garden to release the fluid into the respective container.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to irrigation devices and more particularly pertains to a new irrigation device for automatically irrigating a container garden.

### (2) Description of Related Art Including Information Disclosed Under 37 CFR 1.97 and 1.98

The prior art relates to irrigation devices including a bucket with a plurality of hoses that are each fluidly coupled thereto for routing water from the bucket to containers in a container garden. The prior art also discloses an irrigation system that includes an irrigation pipe with fluid nozzles being coupled thereto which can penetrate soil in a container for watering the soil. The prior art also discloses a mist producing irrigator for watering plants with a mist. The prior art further discloses an irrigation system that has a plurality of faucets on a building, each having an irrigation pipe coupled thereto for watering a plurality of plant containers outside of the building.

### BRIEF SUMMARY OF THE INVENTION

An embodiment of the disclosure meets the needs presented above by generally comprising a reservoir for containing a fluid. A pump is positioned inside the reservoir thereby facilitating the pump to be submerged in the fluid. A control unit provided that is in electrical communication with the pump. The control unit turns the pump on and off at predetermined times of day. A pair of irrigation units is each in fluid communication with the pump to receive the fluid from the pump. Each of the irrigation units has a plurality of irrigation ports therein and each of the irrigation units is positioned over a container garden. Moreover, each of the irrigation ports is aligned with a respective one of a plurality of containers in the container garden to release the fluid into the respective container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a container garden irrigation assembly according to an embodiment of the disclosure.

FIG. 2 is a bottom view of an irrigation unit of an embodiment of the disclosure.

FIG. 3 is a phantom view of reservoir of an embodiment of the disclosure.

FIG. 4 is an exploded perspective view of irrigation unit of an embodiment of the disclosure.

FIG. 5 is a perspective in-use view of an embodiment of the disclosure.

FIG. 6 is a schematic view of an embodiment of the disclosure.

### DETAILED DESCRIPTION OF THE INVENTION

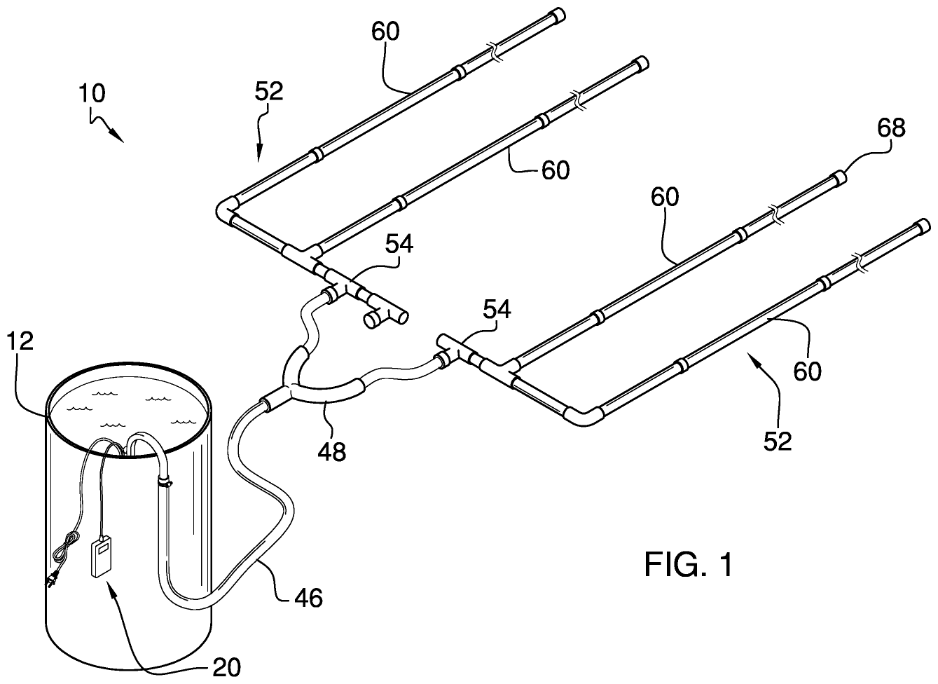

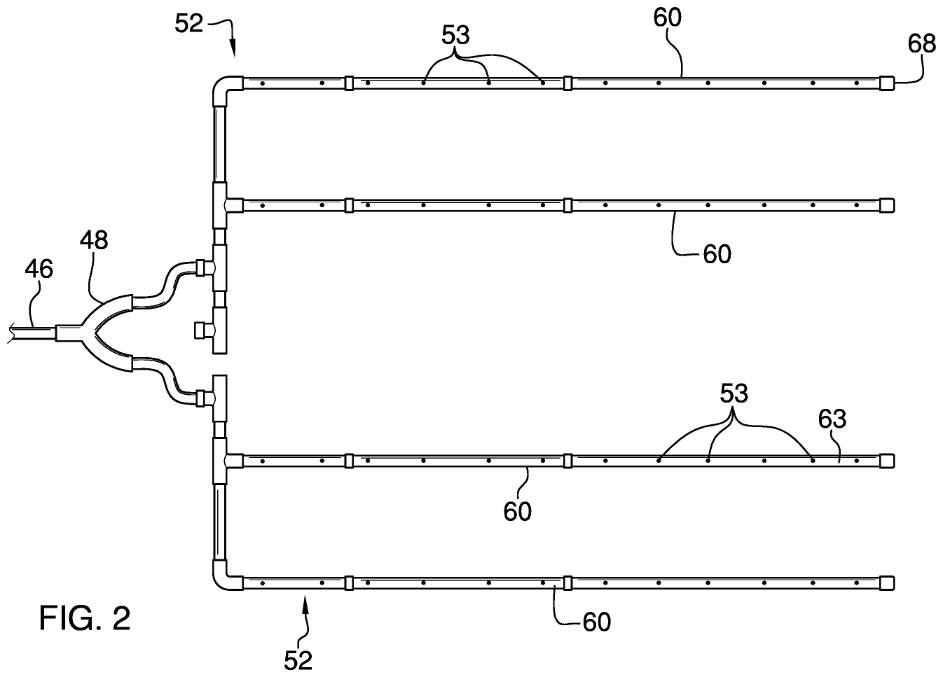

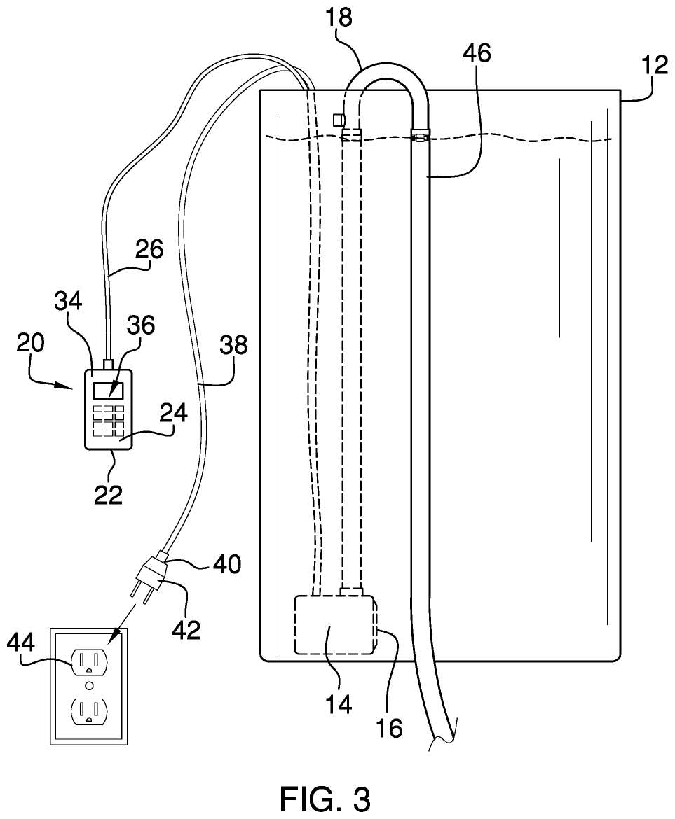

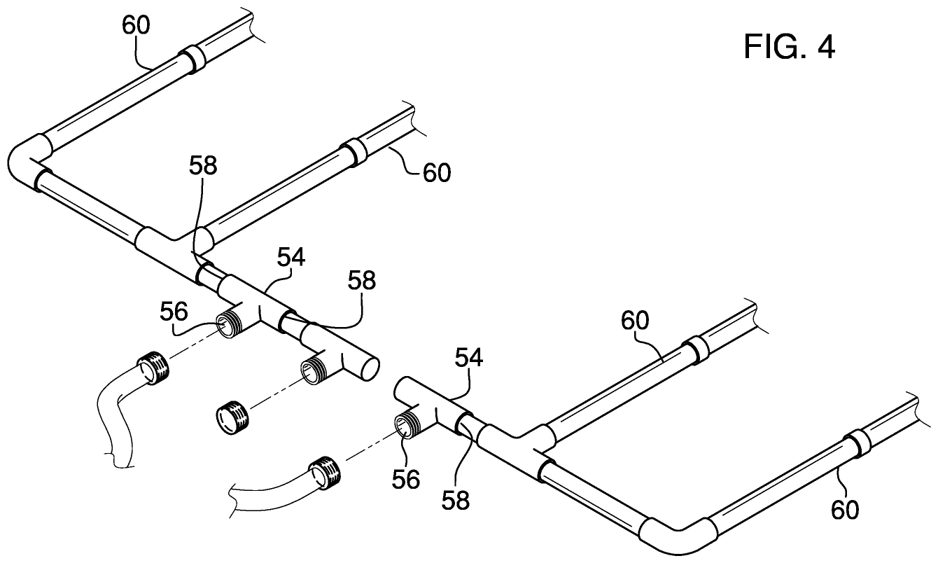

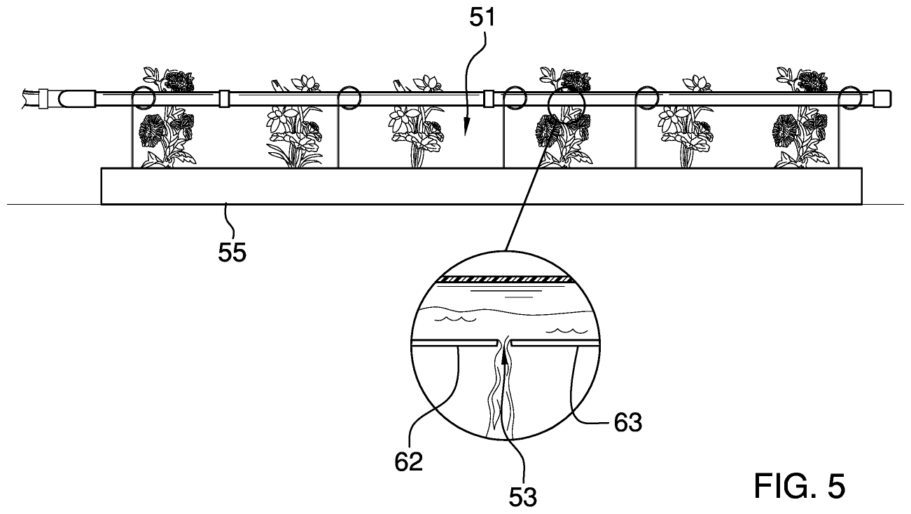

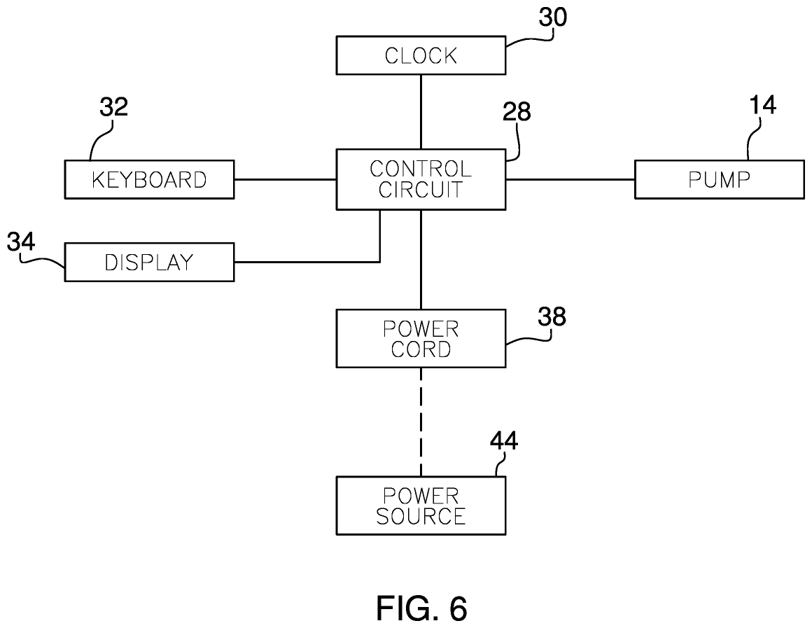

With reference now to the drawings, and in particular to FIGS. 1 through 6 thereof, a new irrigation device embodying the principles and concepts of an embodiment of the disclosure and generally designated by the reference numeral 10 will be described.

As best illustrated in FIGS. 1 through 6, the container garden irrigation assembly 10 generally comprises a reservoir 12 for containing a fluid such as water, a liquid fertilizer or any other liquid commonly employed in agriculture. A pump 14 is positioned inside the reservoir 12 thereby facilitating the pump 14 to be submerged in the fluid. The pump 14 has an intake 16 and an exhaust 18, and the pump 14 urges the fluid inwardly through the intake 16 an outwardly through the exhaust 18 when the pump 14 is turned on. The pump 14 may be a submersible fluid pump of any conventional design.

A control unit 20 is provided and the control unit 20 is positioned adjacent to the reservoir 12. The control unit 20 is in electrical communication with the pump 14 and the control unit 20 turns the pump 14 on and off at predetermined times of day. The control unit 20 comprises a housing 22 has a front wall 24 and a conductor 26 that is coupled between the housing 22 and the pump 14. Additionally, the conductor 26 is electrically coupled to the pump 14. The control unit 20 includes a control circuit 28 that is positioned within the housing 22 and the control circuit 28 is electrically coupled to the conductor 26. The control circuit 28 receives an on input and an off input. The pump 14 is turned on when the control circuit 28 receives the on input and the pump 14 is turned off when the control circuit 28 receives the off input.

The control unit 20 includes a clock 30 that is positioned within the housing 22 and the clock 30 is electrically coupled to the control circuit 28. The clock 30 tracks the time of day and the control circuit 28 receives the on input when the clock 30 reaches a pre-determined watering time. Additionally, the control circuit 28 receives the off input when a pre-determined duration of time has passed after the watering time. A keyboard 32 is positioned on the front wall 24 of the housing 22 and the keyboard 32 is electrically coupled to the control circuit 28. The keyboard 32 is manipulated to program the pre-determined watering time into the clock 30 and to program the pre-determined duration of time into the clock 30.

A display 34 is coupled to the front wall 24 of the housing 22 and the display 34 is electrically coupled to the control circuit 28. The display 34 displays indicia 36 comprising words and numbers for communicating operational parameters of the clock 30 and the control circuit 28. The display 34 may comprise an LCD or other type of electronic display 34. A power cord 38 is coupled to and extends away from the conductor 26 and the power cord 38 has a distal end 40 with respect to the conductor 26. The distal end 40 has a male plug 42 that is electrically coupled thereto for plugging into a power source 44 comprising a female electrical outlet.

A primary hose 46 is fluidly coupled to the pump 14 to receive the fluid pumped by the pump 14, and the primary hose 46 is fluidly coupled to the exhaust 18 of the pump 14. A hose splitter 48 is provided and the primary hose 46 is fluidly coupled to the hose splitter 48. A pair of secondary hoses 50 and each of the secondary hoses 50 is fluidly coupled to the hose splitter 48 to receive the fluid. The hose splitter 48 may be a fluid fitting that has a single input and a pair of outputs, such as a Y fitting or the like.

A pair of irrigation units 52 is provided and each of the irrigation units 52 is in fluid communication with the pump 14 to receive the fluid from the pump 14. Each of the irrigation units 52 has a plurality of irrigation ports 53 therein. Each of the irrigation units 52 is positioned over a container garden 51 and each of the irrigation ports 53 is aligned with a respective one of a plurality of containers 55 in the container garden 51. In this way each of the irrigation ports 53 releases the fluid into the respective container. In this way plants that are being grown in the container garden 51 can be automatically irrigated.

Each of the irrigation units 52 includes an inlet fitting 54 that has an input 56 and a pair of outlets 58. The input 56 comprises a hose bib that fluidly engages a respective one of the secondary hoses 50 to receive the fluid. The inlet fitting 54 may be a T fitting or the like such that each of the outlets 58 directs the flow of fluid perpendicular to the direction of flow of the input 56. Each of the irrigation units 52 includes a plurality of irrigation pipes 60 that is each in fluid communication with the inlet fitting 54 to receive the fluid.

Each of the irrigation pipes 60 has an outer wall 62 and each of the irrigation ports 53 extends through the outer wall 62 of the respective irrigation pipe 60. The irrigation ports 53 are spaced apart from each other and are distributed along a full length of the irrigation pipes 60. Each of the irrigation ports 53 is positioned on a bottom side 63 of the irrigation pipes 60. Moreover, each of the irrigation pipes 60 is horizontally oriented above a line of containers 55 in the container garden 51 thereby facilitating the irrigation ports 53 to drip the fluid into the containers 55. A terminal end 68 of each of the irrigation pipes 60 is capped off to ensure the fluid only escapes the irrigation pipes 60 through the irrigation ports 53.

In use, the reservoir 12 is filled with the fluid and the power cord 38 is plugged into the power source 44. The keyboard 32 is manipulated to program the time of day to schedule the watering time and to program the duration of time over which the watering time should occur. The pump 14 is turned on at the watering time and the pump 14 is turned off after the duration of time selected for the watering time. In this way the irrigation ports 53 drip the fluid into the containers 55 at the selected times of day and for the selected duration of time. In this way the container garden 51 can be automatically irrigated without requiring a person to be present.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A container garden irrigation assembly for automatically watering each container in a container garden without supervision, said assembly comprising:
a reservoir for containing a fluid;
a pump being positioned inside said reservoir thereby facilitating said pump to be submerged in the fluid;
a control unit being positioned adjacent to said reservoir, said control unit being in electrical communication with said pump, said control unit turning said pump on and off at predetermined times of day; and
a pair of irrigation units, each of said irrigation units being in fluid communication with said pump wherein each of said irrigation units is configured to receive the fluid from said pump, each of said irrigation units having a plurality of irrigation ports therein, each of said irrigation units being positioned over a container garden having each of said irrigation ports being aligned with a respective one of a plurality of containers in the container garden wherein each of said irrigation ports is configured to release the fluid onto the respective container.

2. The assembly according to claim 1, wherein said control unit comprising:
a housing having a front wall;
a conductor being coupled between said housing and said pump, said conductor being electrically coupled to said pump; and
a control circuit being positioned within said housing, said control circuit being electrically coupled to said conductor, said control circuit receiving an on input and an off input, said pump being turned on when said control circuit receives said on input, said pump being turned off when said control circuit receives said off input.

3. The assembly according to claim 2, wherein said control unit includes a clock being positioned within said housing, said clock being electrically coupled to said control circuit, said clock tracking the time of day, said control circuit receiving said on input when said clock reaches a pre-determined watering time, said control circuit receiving said off input when a pre-determined duration of time has passed after the watering time.

4. The assembly according to claim 3, wherein said control unit includes a keyboard being positioned on said front wall of said housing wherein said keyboard is configured to be manipulated by a user, said keyboard being electrically coupled to said control circuit, said keyboard programming said pre-determined watering time into said clock, said keyboard programming said pre-determined duration of time into said clock.

5. The assembly according to claim 3, wherein said control unit includes a display being coupled to said front wall of said housing, said display being electrically coupled to said control circuit, said display displaying indicia comprising words and numbers for communicating operational parameters of said clock and said control circuit.

6. The assembly according to claim 2, wherein said control unit includes a power cord being coupled to and extending away from said conductor, said power cord having a distal end with respect to said conductor, said distal end having a male plug being electrically coupled thereto wherein said male plug is configured to be plugged into a power source comprising a female electrical outlet.

7. The assembly according to claim 1, wherein:
said pump has an intake and an exhaust, said pump urging the fluid inwardly through said intake an outwardly through said exhaust when said pump is turned on;
a primary hose being fluidly coupled to said pump wherein said primary hose is configured to receive the fluid pumped by said pump, said primary hose being fluidly coupled to said exhaust of said pump.

8. The assembly according to claim 7, further comprising:
a hose splitter having said primary hose being fluidly coupled thereto; and
a pair of secondary hoses, each of said secondary hoses being fluidly coupled to said hose splitter wherein each of said secondary hoses is configured to receive the fluid.

9. The assembly according to claim 8, wherein each of said irrigation units includes an inlet fitting, said inlet fitting having an input and a pair of outlets, said input comprising a hose bib, said hose bib fluidly engaging a respective one of said secondary hoses wherein said inlet fitting is configured to receive the fluid.

10. The assembly according to claim 9, wherein:
each of said irrigation units includes a plurality of irrigation pipes, each of said irrigation pipes being in fluid communication with said inlet fitting wherein said irrigation pipes are configured to receive the fluid;
each of said irrigation pipes has an outer wall, said outer wall of each of said irrigation pipes having said irrigation ports extending therethrough, said irrigation ports being spaced apart from each other and being distributed along a full length of said irrigation pipes, each of said irrigation ports being positioned on a bottom side of said irrigation pipes; and
each of said irrigation pipes is horizontally oriented above a line of containers in the container garden thereby facilitating said irrigation ports to drip the fluid into the containers.

11. A container garden irrigation assembly for automatically watering each container in a container garden without supervision, said assembly comprising:
a reservoir for containing a fluid;
a pump being positioned inside said reservoir thereby facilitating said pump to be submerged in the fluid, said pump having an intake and an exhaust, said pump urging the fluid inwardly through said intake an outwardly through said exhaust when said pump is turned on;
a control unit being positioned adjacent to said reservoir, said control unit being in electrical communication with said pump, said control unit turning said pump on and off at predetermined times of day, said control unit comprising:
a housing having a front wall;
a conductor being coupled between said housing and said pump, said conductor being electrically coupled to said pump;
a control circuit being positioned within said housing, said control circuit being electrically coupled to said conductor, said control circuit receiving an on input and an off input, said pump being turned on when said control circuit receives said on input, said pump being turned off when said control circuit receives said off input;
an clock being positioned within said housing, said clock being electrically coupled to said control circuit, said clock tracking the time of day, said control circuit receiving said on input when said clock reaches a pre-determined watering time, said control circuit receiving said off input when a pre-determined duration of time has passed after the watering time;
a keyboard being positioned on said front wall of said housing wherein said keyboard is configured to be manipulated by a user, said keyboard being electrically coupled to said control circuit, said keyboard programming said pre-determined watering time into said clock, said keyboard programming said pre-determined duration of time into said clock;
a display being coupled to said front wall of said housing, said display being electrically coupled to said control circuit, said display displaying indicia comprising words and numbers for communicating operational parameters of said clock and said control circuit; and
a power cord being coupled to and extending away from said conductor, said power cord having a distal end with respect to said conductor, said distal end having a male plug being electrically coupled thereto wherein said male plug is configured to be plugged into a power source comprising a female electrical outlet;
a primary hose being fluidly coupled to said pump wherein said primary hose is configured to receive the fluid pumped by said pump, said primary hose being fluidly coupled to said exhaust of said pump;
a hose splitter having said primary hose being fluidly coupled thereto;
a pair of secondary hoses, each of said secondary hoses being fluidly coupled to said hose splitter wherein each of said secondary hoses is configured to receive the fluid; and
a pair of irrigation units, each of said irrigation units being in fluid communication with said pump wherein each of said irrigation units is configured to receive the fluid from said pump, each of said irrigation units having a plurality of irrigation ports therein, each of said irrigation units being positioned over a container garden having each of said irrigation ports being aligned with a respective one of a plurality of containers in the container garden wherein each of said irrigation ports is configured to release the fluid onto the respective container, each of said irrigation units including:
a inlet fitting, said inlet fitting having an input and a pair of outlets, said input comprising a hose bib, said hose bib fluidly engaging a respective one of said secondary hoses wherein said inlet fitting is configured to receive the fluid; and
a plurality of irrigation pipes, each of said irrigation pipes being in fluid communication with said inlet fitting wherein said irrigation pipes are configured to receive the fluid, each of said irrigation pipes having an outer wall, said outer wall of each of said irrigation pipes having said irrigation ports extending therethrough, said irrigation ports being spaced apart from each other and being distributed along a full length of said irrigation pipes, each of said irrigation ports being positioned on a bottom side of said irrigation pipes, each of said irrigation pipes being horizontally oriented above a line of containers in the container garden thereby facilitating said irrigation ports to drip the fluid into the containers.
